(19) United States
(12) Patent Application Publication
(10) Pub. No.: US 2018/0256289 A1
(43) Pub. Date: Sep. 13, 2018

(54) POWERED COUPLER FOR DENTAL HANDPIECE

(71) Applicant: KAVO DENTAL TECHNOLOGIES, LLC, Charlotte, NC (US)

(72) Inventors: Robert Thomas St. Louis, Charlotte, NC (US); Michael Carl Dunaway, Charlotte, NC (US); Steven Bohon, Charlotte, NC (US)

(21) Appl. No.: 15/456,227

(22) Filed: Mar. 10, 2017

(51) Int. Cl. A61C 1/08; A61C 1/06; A61C 1/00

(52) U.S. Cl. CPC A61C 1/08; A61C 1/0084; A61C 1/06

(57) ABSTRACT

A coupling device for selectively coupling a dental handpiece to a dental base station. An electrical power source is housed by the coupling device. A first end of the coupling device is selectively coupleable to the dental base station and configured to receive a gaseous or fluid medium from the dental base station. A second end of the coupling device is selectively coupleable to the dental handpiece and configured to output the gaseous or fluid medium from the dental base station to the dental handpiece and to output electrical power from the electrical power source to the dental handpiece.

### BACKGROUND

Embodiments relate to systems and methods for coupling a dental handpiece to a base station.

### SUMMARY

One embodiment provides a coupling device for selectively coupling a dental handpiece to a dental base station. An electrical power source is housed by the coupling device. A first end of the coupling device is selectively coupleable to the dental base station and configured to receive a gaseous or fluid medium from the dental base station. A second end of the coupling device is selectively coupleable to the dental handpiece and configured to output the gaseous or fluid medium from the dental base station to the dental handpiece and to output electrical power from the electrical power source to the dental handpiece.

In some embodiments, the electrical power source includes a rechargeable battery and a battery charger. In some embodiments, the battery charger of the electrical power source includes one or more photovoltaic cells mounted on an exterior surface of the coupling device. In other embodiments, the battery charger of the electrical power source includes a thermoelectric generator, an acoustic generator, and air or water-powered generator (e.g., dynamo), or an inductive charging circuit.

In some embodiments, the coupling device includes a coupler body housing that is directly coupleable to a body of the dental handpiece so that the coupler body housing is supported by the dental handpiece during use of the dental handpiece. In other embodiments, the coupling device includes a first length of hose selectively coupleable to the dental base station between a coupler body housing and the dental base station and a second length of hose selectively coupleable to the dental handpiece between the coupler body housing and the dental handpiece.

Another embodiment provides a method of retrofitting a dental handpiece to a dental base station. The dental handpiece requires both electrical power and a gaseous or fluid medium for operation. The dental base station is configured to provide the gaseous or fluid medium to the dental handpiece, but is not configured to provide electrical power to the dental handpiece. The dental base station is coupled to a first end of the coupling device and the dental handpiece is coupled to a second end of the coupling device. The gaseous or fluid medium is conveyed from the dental base station to the dental handpiece through the coupling device. Electrical power is conveyed to the dental handpiece from a power supply at least partially housed by the coupling device.

Other aspects of various embodiments will become apparent by consideration of the detailed description and accompanying drawings.

### BRIEF DESCRIPTION OF THE DRAWINGS

FIG. 1 is a block diagram of a first example of dental system configuration in which a dental handpiece is coupled to a dental base station in accordance with some embodiments.

FIG. 2 is a block diagram of a second example of a dental system configuration in which a dental handpiece is coupled to a dental base station in accordance with some embodiments.

FIG. 3 is a block diagram of a third example of a dental system configuration in which a coupling device is used to couple a dental handpiece to a dental base station.

FIG. 4 is an elevation view of an example of a dental system configuration according to FIG. 3 in which a hose-type coupling device is used to couple the dental handpiece to the dental base station.

FIG. 5 is a partially-transparent perspective view of a coupling device for use in the dental system configuration of FIG. 3 including a wireless charging circuit for charging a battery housed within the coupling device.

FIG. 6 is a partially-transparent perspective view of a coupling device for use in the dental system of FIG. 3 including a photovoltaic device for charging a battery housed within the coupling device.

### DETAILED DESCRIPTION

Before any embodiments are explained in detail, it is to be understood that the embodiments are not limited in their application to the details of construction and the arrangement of components set forth in the following description or illustrated in the following drawings. Embodiments may be practiced and carried out in various ways.

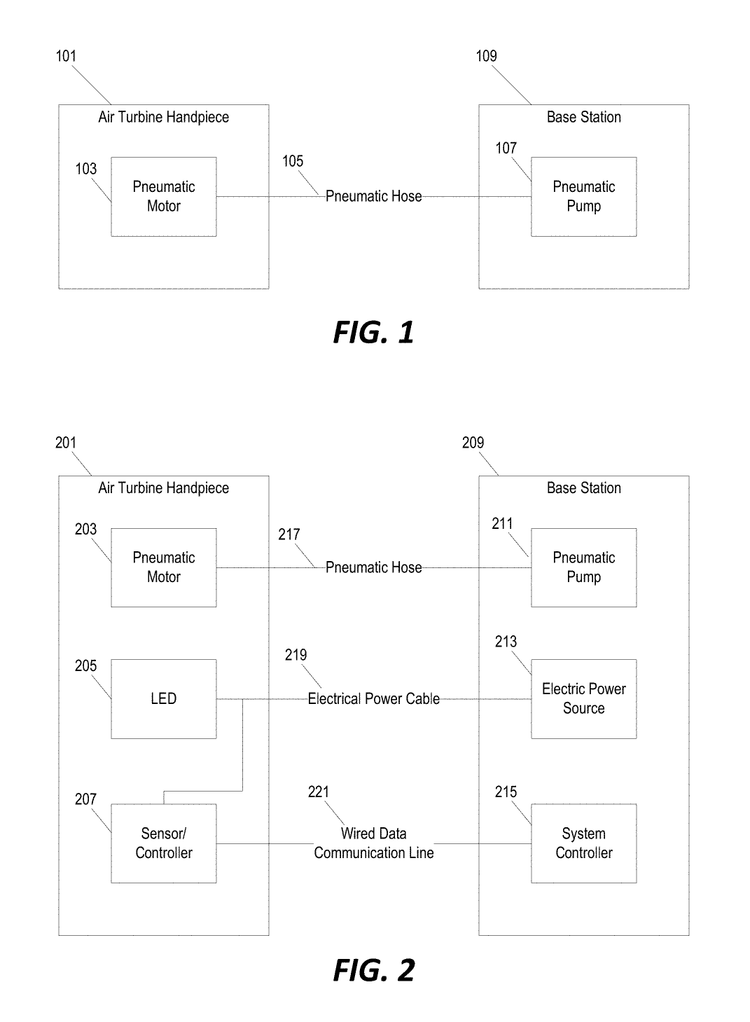

Dental practitioners often use dental handpieces including, for example, an air turbine handpiece or “drill.” FIG. 1 illustrates one example of a dental system including an air turbine handpiece 101. The air turbine handpiece 101 includes a pneumatic motor 103 (e.g., an air-turbine that is configured to rotate when pressurized air moves through the handpiece) that is coupled by a pneumatic hose 105 to a pneumatic pump 107 of a dental base station 109 or “delivery unit.” The pneumatic pump 107 provides pressurized air through the pneumatic hose 105 to the pneumatic motor 103 of the air turbine handpiece 101. The operation of the pneumatic motor 103, in turn, causes rotation of a drill tip of the air turbine handpiece 101. In various implementations, the pneumatic pump 107 can be provides as an integral component of the dental base station 109 or as a separate component that is separately coupled to the dental base station and provides pressurized air to the air turbine handpiece 101 (and/or other devices) through the dental base station 103.

In some implementations, such as illustrated in the example of FIG. 1 and other examples discussed further below, the pneumatic pump 107 is provided as a

The example of FIG. 1 illustrates a simplified system in which only pressurized air is conveyed between the dental base station 109 and the air turbine handpiece 101. In other implementations, one or more additional hoses may be provided for conveyance of another gaseous or fluid medium between the dental handpiece and the dental base station. For example, in addition to the pneumatic hose 105 for operating the pneumatic motor 103, the handpiece 101 in other implementations may also be configured to include a fluid hose for conveying water from the dental base station 109 to the air turbine handpiece 101. The handpiece 101 may then be configured to utilize this water to reduce the temperature of (i.e., “cool”) the rotating drill tip or to rinse the mouth of a patient.

In still other implementations, a dental handpiece may include additional components—including, for example, an electronic controller—that require electrical power or a data communication channel. FIG. 2 illustrates an example of an air turbine handpiece 201 that includes a pneumatic motor 203 for causing rotation of the drill tip, a light emitting diode (LED) 205 for illuminating the oral cavity of a patient during use of the air turbine handpiece 201, and one or more sensors or electronic controllers 207 for monitoring conditions including, for example, the operating temperature of the air turbine handpiece and/or controlling the operation of the air turbine handpiece. In the example of FIG. 2, the dental base station 209 includes a pneumatic pump 211, an electric power source 213, and a system controller 215. Similar to the example of FIG. 1, the pneumatic pump 211 is coupled to the pneumatic motor 203 by a pneumatic hose 217 that provides pressurized air to operate the pneumatic motor 203. The electric power source is coupled to the LED 205 and the sensor/controller 207 by an electrical power cable 219 to provide operating power to the components of the air turbine handpiece 201. The system controller 215 is also coupled to the sensor/controller 207 by a wired data communication line 221 to transmit sensor data and/or digital command instructions between the base station 209 and the air turbine handpiece 201. In some implementations, the pneumatic hose 217, the electrical power cable 219, and the wired data communication line 221 are all integrated as different conveyance channels within a single coupling cable between the air turbine handpiece 201 and the base station 209.

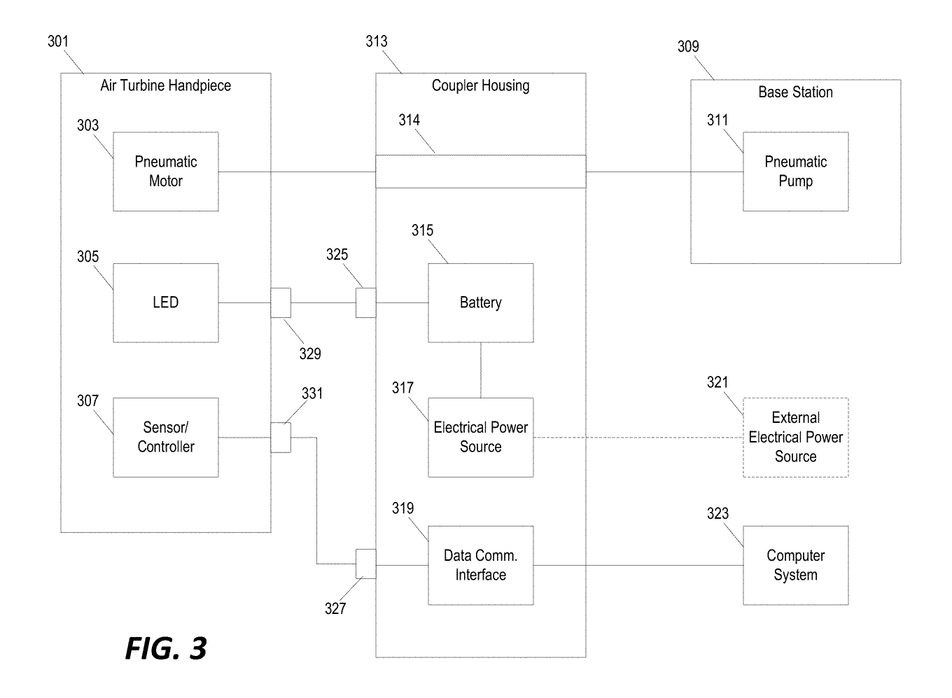

In some dental system configurations, a dental practitioner may desire to use a dental handpiece (for example, the air turbine handpiece 201 of FIG. 2) that includes electrically powered components. However, a base station that is not configured to provide electrical power (for example, the base station 109 of FIG. 1) may be the only base station available. FIG. 3 illustrates an example of a dental system configuration in which a coupling device is used to facilitate a coupled connection between a dental handpiece that requires electrical power and a base station that is not configured to provide power. As in the example of FIG. 2, the configuration of FIG. 3 includes an air turbine handpiece 301 that includes a pneumatic motor 303, an LED 305, and one or more sensors or controllers (for example, sensor/controller 307). However, the base station 309 is only configured to provide pressurized air using a pneumatic pump 311.

The example of FIG. 3 also includes a coupling device 313 coupled between the air turbine handpiece 301 and the base station 309. The coupling device 313 that includes a medium conveyance channel 314 that in one embodiment extends from a first end of the coupling device 313 to a second end of the coupling device. The medium conveyance channel 314 is configured to convey the pressurized air from the pneumatic pump 311 to the pneumatic motor 303 of the air turbine handpiece 301. The coupling device 313 also includes a battery 315, an electrical power source 317, and a data communication interface 319. In some implementations, the first end of the coupling device 313 (or, more particularly, the first end of the medium conveyance channel 314) is selectively coupleable to the base station 309 through a flexible hose. Similarly, in some implementations, the second end of the coupling device 313 (or, more particularly, the second end of the medium conveyance channel 314) is selectively coupleable to the air turbine handpiece 301 through a flexible hose.

The electrical power source 317 generates electrical power that is then stored to the battery 315. During operation of the air turbine handpiece 301, the stored electrical power from the battery 315 is provided to the air turbine handpiece 305 to illuminate the LED 305 and, in some implementations, to provide operating power to the sensor/controller 307. In some implementations, the electrical power source 317 includes a wireless charging device—for example, an inductive charging circuit—that receives electrical power from an external electrical power source 321. In other implementations, the electrical power source 317 includes a circuit or device configured to generate its own electricity. For example, the electrical power source 317 may include one or more photovoltaic cells to capture energy from ambient light (for example, operatory lights used in the room). Alternatively or additionally, the electrical power source 317 may include an acoustic generator (for example, a voice coil) configured to generate electrical power from captured sonic or acoustic energy including, for example, sounds produced by operation of the air turbine handpiece 301 (or other dental handpieces/equipment). Other implementations may include an air-powered or water-powered generator (e.g., dynamo) as the electrical power source 317 configured to generate electricity from the movement of the fluid or gaseous medium moving through the coupling device 313.

In still other implementations, the electrical power source 317 includes a thermoelectric (for example, Peltier) generator configured to capture thermal energy and convert it to electrical power. The thermoelectric generator may be configured to generate electricity from thermal heat given off by the hand of the dental practitioner holding and operating the air turbine handpiece 301. As some thermoelectric generators utilize a “hot side” and a “cool side and generate electricity from the temperature differential between the hot side and cool side, the coupling device 313 may be configured to position a hot side contact at a location where it will receive heat from the hand of the operator and to position a cool side contact at a location proximal to the medium conveyance channel allowing the temperature of the cool side contact to be regulated by the air/water supplied through the coupling device to the air turbine handpiece 301. Accordingly, in some implementations, the hot side contact of the thermoelectric generator is positioned and configured to be warmed by the hand of the operator of the dental handpiece when the dental handpiece is in use and the cool side contact of the thermoelectric generator is positioned and configured to be cooled by the fluid medium conveyed through the coupling device. Conversely, in implementations where the liquid conveyed through the coupling device 313 is heated and expected to be warmer than the ambient air or the hand of the operator, the hot side contact may be positioned and configured to be warmed by the fluid medium conveyed through the coupling device and the cool side contact is positioned and configured to be “cooled” by the hand of the operator or by the ambient air.

The data communication interface 319 can include either a wired or wireless interface to transmit data or otherwise facilitating data transfer between the sensor/controller 307 of the air turbine handpiece 301 and an external computer system 323. The data communication interface 319 can include, for example, a wireless data transceiver configured to communicate using one or more communication protocols including, for example, Bluetooth, Wi-Fi, NFC, or other standardized or proprietary wireless communication protocols configured to communicatively couple the wireless data transceiver to the air turbine handpiece 301. In implementations that provide for wired data communication between the coupling device 313 and the external computer system 323, the data communication interface 319 may include a wired data port incorporated into the exterior housing of the coupling device 313 that is selectively connectable to the external computer system 323 (for example, through a standard Ethernet cable, USB cable, or other cable type).

The housing, position, and appearance of the coupling device 313 can vary in different implementations. For example, in the implementation illustrated in FIG. 3, the coupling device 313 includes an electrical power output connector 325 and a data connector 327. When the coupling device 313 is connected to the air turbine handpiece 301, the electrical power output connector 325 and the data connector 327 of the coupling device 313 are connected to an electrical power input connector 329 and a second data connector 331 of the air turbine handpiece 301, respectively, either directly or through a cable. When the electrical power output connector 325 is coupled to the electrical power input connector 329, electrical power from the battery 315 is provided to the LED 305 or other electronic components of the air turbine handpiece 301. Similarly, when the data connector 327 of the coupling device 313 is connected to the second data connector 331 of the air turbine handpiece 301, a wired communication link is established between the data communication interface 319 of the coupling device 313 and the air turbine handpiece 301.

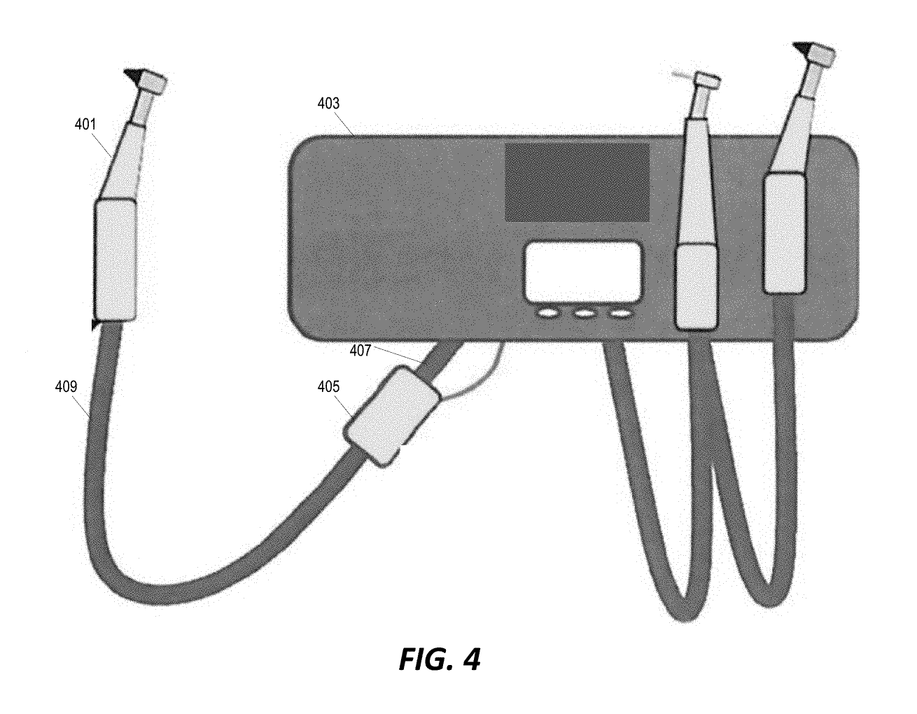

FIG. 4 illustrates another example where the dental handpiece 401 is connected to the dental base station 403 with a configuration that includes a coupler housing 405. A first end of the coupler housing 405 is connected to the dental base station 407 by a first length of hose 407 (for example, a flexible hose). A second end of the coupler housing 405 (opposite the first end) is connected to the dental handpiece 401 by a second length of hose 409 (for example, a flexible hose). In this example, the coupler housing 405 includes a medium conveyance channel (for example, medium conveyance channel 314 from the example of FIG. 3) allowing pressurized air to pass from the dental base station 403, through the first length of hose 407, through the coupler housing 405, through the second length of hose 409, and ultimately to the dental handpiece 401. The second length of hose 409 includes a pressurized air channel (for example, pneumatic hose 217 from the example of FIG. 2), an electrical power cable (for example, electrical power cable 219 from the example of FIG. 2), and a wired data communication line (for example, wired data communication line 221 from the example of FIG. 2) integrated as separate channels or lines in a single hose. However, because the base station 403 is not configured to provide electrical power or to facilitate data communication, in some implementations, the first length of hose 407 does not include the electrical power cable or the wired data communication line. Accordingly, in some implementations, the first length of hose 407 includes only a pneumatic hose.

In the example of FIG. 4, the first length of hose 407 is significantly shorter than the second length of hose 409. By this configuration, the weight of the coupler housing 405 and the components housed inside is supported primarily by the dental base station 403 through the first length of hose 407 and less of the weight must be supported by the operator of the dental handpiece 401 during use. In still other implementations, the coupler housing 405 is configured to be coupled to the dental base station 403 by a mechanism other than the first length of hose 407 itself. For example, in some implementations, the coupler housing 405 may be directly coupleable to the dental base station 403 with a first length of hose 407 and, in other implementations, a support linkage (e.g., a chain or wire cable) may be provided to couple coupler housing 405 to the dental base station 403 so that the weight of the coupler housing 405 is supported by the support linkage and not by the first length of hose 407.

In some implementations, the system configuration illustrated in FIG. 4 provides for advances features to be incorporated into the dental handpiece 401 while simplifying the construction of the dental base station 403. For example, rather than using a complex base station to collect and monitor sensor data from the sensor/controller of the dental handpiece, the dental handpiece 401 in the example of FIG. 4 can be configured to communicate wirelessly with a desktop/laptop computer, a tablet computer, a smart phone, or other external computing device to provide this and other functionality.

In other implementations, the coupling device of FIG. 4 can be used for retrofitting purposes to provide the full functionality of an advanced electrically-powered dental handpiece 401 with an older dental base station 403. For example, the coupling device illustrated in FIG. 4 can be used to couple the base station 109 of FIG. 1 to the air turbine handpiece 201 of FIG. 2. In this example of a retrofitting arrangement, the pneumatic hose 105 of FIG. 1 can be used as the first length of hose 407 shown in FIG. 4 connecting the coupler housing 405 to the dental base station 403. Similarly, a combined hose/coupling cable including the pneumatic hose 217, the electrical power cable 219, and the wired data communication line 221 from the example of FIG. 2 can be used as the second length of hose 409 shown in FIG. 4 connecting the coupler housing 405 to the dental handpiece 401.

In some implementations (whether designed for retrofitting or otherwise), the coupler housing 405 may be fixedly connected to both the first length of hose 407 and the second length of hose 409. Accordingly, in some implementations of this type, a single continuous pneumatic hose runs through the first length of hose 407, the coupler housing 405, and the second length of hose 409. In other implementations, the coupler housing 405 is fixedly connected to the second length of hose 409, but selectively coupleable to the first length of hose 407, or, similarly, the coupler housing 405 is fixedly connected to the first length of hose 407, but selectively coupleable to the second length of hose 409. In still other implementations, the coupler housing 405 is selectively coupleable to both the first length of hose 407 and the second length of hose 409 as in the retrofitting example discussed above.

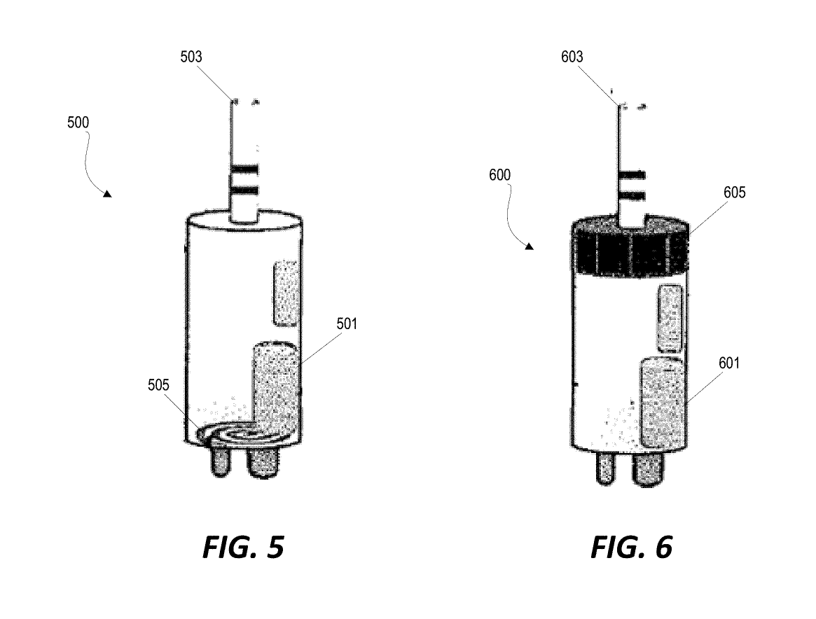

In the example of FIG. 4, the coupler housing 405 is supported by or integrated into the hose connecting the dental handpiece 401 to the dental base station 403. However, in other implementations, a coupler housing containing, for example, the battery 315, the electrical power source 317, and the data communication interface 319 as illustrated in FIG. 3 is directly coupleable to and directly supported by either the dental handpiece 401 or the dental base station 403. For example, FIGS. 5 and 6 illustrate examples of coupler body housings that are configured to attach directly to the base of a dental handpiece and, accordingly, will be held by the operator during use of the dental handpiece. Because the coupler body housings as illustrated in the examples of FIGS. 5 and 6 attached directly to the dental handpiece, only a single length of hose is required to connect the coupler body housing to the base station. As used in this patent application, the phrase “coupler body housing” refers to a type of coupler housing that attaches directly to the body of either the dental handpiece or the dental base station.

FIG. 5 illustrates a first example of a coupler body housing 500. A battery 501 is positioned within the coupler body housing 500 to provide electrical power to an LED 503. The coupler body housing 500 also includes a wireless charging coil 505 that is configured to charge the battery 501. Because the coupler body housing 500 in this example is directly attachable to the dental handpiece, in some implementations, a corresponding mating charger is integrated into an instrument holder and configured to induce an electrical current in the wireless charging coil 505 (for example, by inductive charging) when the dental handpiece is placed in the instrument holder while not in use.

FIG. 6 illustrates another example of a coupler body housing 600 that also includes a battery 601 to provide electrical power to an LED 603. However, instead of a wireless charging coil, the coupler body housing 600 includes a series of photovoltaic (i.e., solar) cells 605 arranged around the circumference of the cylindrical shaped coupler body housing 600. The photovoltaic cells 605 generate electrical power to charge the battery 601 when exposed to light (for example, from the operatory lights used during operation of the dental handpiece). As discussed above, the photovoltaic cells 605 in the coupler body housing 600 of FIG. 6 is only one example of a type of electrical power source that can be incorporated into the coupler body housing to charge the battery. In other implementations, the coupler body housing 600 can instead be equipped with, for example, a thermoelectric generator (for example, a Peltier generator) or an acoustic generator (for example, a voice coil).

In the examples discussed above in reference to FIGS. 3 and 4, an LED is integrated into the dental handpiece and is “electrically coupled” to the coupling device by an electric cable that conveys electrical power from the battery of the coupling device to the LED of the dental handpiece. However, in other implementations, an electrical component/device is provided as a part of the coupling device and is “operatively coupled” to the dental handpiece. For example, in the coupling body housing of FIG. 5, the LED 503 is provided as part of the coupling device and is operatively coupled to the dental handpiece by a fiber optic cable that conveys light emitted by the LED 503 in the coupling body housing into the dental handpiece where the light is output for use (for example, to illuminate the oral cavity during use of an air turbine handpiece). In other implementations, an LED or other electrical device/component may be positioned, for example, in the coupler housing 405 of FIG. 4 and operatively coupled to the dental handpiece 401 (for example, by a fiber optic cable) through the second length of hose 409. In still other implementations, types of electrical devices/components other than an LED are provided as part of the coupling device and are operatively coupled to the dental handpiece by mechanisms other than a fiber optic cable.

Thus, embodiments provide, among other things, a coupling device with an integrated electrical power source for selectively coupling a dental handpiece to a dental base station. Various features and advantages of the certain embodiments are set forth in the following claims.

What is claimed is:

1. A coupling device for selectively coupling a dental handpiece to a dental base station, the coupling device comprising:
a first end selectively coupleable to the dental base station and configured to receive a gaseous or fluid medium from the dental base station;
an electrical power source housed by the coupling device; and
a second end selectively coupleable to the dental handpiece and configured to output the gaseous or fluid medium from the dental base station to the dental handpiece and to output electrical power from the electrical power source to the dental handpiece.

2. The coupling device of claim 1, further comprising a medium conveyance channel extending from the first end to the second end and configured to convey the gaseous or fluid medium from the dental base station to the dental handpiece when the first end is coupled to the dental base station and the second end is coupled to the dental handpiece.

3. The coupling device of claim 1, further comprising an electrical power output connector positioned proximal to the second end of the coupling device, coupled to the electrical power source, and configured to couple to an electrical power input connector of the dental handpiece when the second end is coupled to the dental handpiece.

4. The coupling device of claim 1, wherein the electrical power source of the coupling device includes a rechargeable battery and a battery charger.

5. The coupling device of claim 4, wherein the battery charger includes one or more photovoltaic cells mounted on an exterior surface of the coupling device.

6. The coupling device of claim 4, wherein the battery charger includes thermoelectric generator configured to generate electrical power used to charge the rechargeable battery from an electrical current generated from a temperature differential between components of the dental handpiece.

7. The coupling device of claim 6, wherein the first end is configured to receive a fluid medium from the dental base station and the second end is configured to output the fluid medium from the dental base station to the dental handpiece,
wherein the thermoelectric generator includes a hot side contact and a cool side contact and generates the electrical current from the temperature differential between the hot side contact and the cool side contact,
wherein the hot side contact of the thermoelectric generator is positioned and configured to be warmed by the hand of the operator of the dental handpiece when the second end of the coupling device is coupled to the dental handpiece and the dental handpiece is in use, and
wherein the cool side contact of the thermoelectric generator is positioned and configured to be cooled by the fluid medium conveyed through the coupling device from the dental base station to the dental handpiece.

8. The coupling device of claim 4, wherein the battery charger includes an inductive charging circuit configured to charge the rechargeable battery using electrical power from an external electrical power source.

9. The coupling device of claim 4, wherein the battery charger includes an acoustic generator configured to capture acoustic energy from sound produced by operation of the dental handpiece and to convert the acoustic energy into an electrical current.

10. The coupling device of claim 1, further comprising a wireless data transceiver and a data connector,
wherein the data connector is positioned proximal to the second end of the coupling device, coupled to the wireless data transceiver, and configured to communicatively couple the wireless data transceiver to the dental handpiece when the second end is coupled to the dental handpiece, and
wherein the wireless data transceiver is configured to provide communication between the dental handpiece and an external computer system when the coupling device is coupled to the dental handpiece.

11. The coupling device of claim 1, further comprising a wired data port and a data connector,
wherein the data connector is positioned proximal to the second end of the coupling device, coupled to the wired data port, and configured to establish a wired communication link between the wired data port and the dental handpiece when the second end is coupled to the dental handpiece,
wherein the wired data port is selectively connectable to an external computer system through a wired connection, and
wherein the wired data port is configured to provide communication between the dental handpiece and the external computer system when the coupling device is coupled to the dental handpiece and the wired data port is coupled to the external computer system.

12. The coupling device of claim 1, further comprising a coupler body housing including the first end and the second end, wherein the electrical power source is at least partially housed by the coupler body housing,
wherein the second end is directly coupleable to a body of the dental handpiece and is supported by the dental handpiece during use of the dental handpiece, and
wherein the first end is coupleable to the dental base station through a flexible hose configured to convey the gaseous or fluid medium from the dental base station to the first end of the coupling device.

13. The coupling device of claim 1, further comprising a coupler housing selectively coupleable to the dental base station such that, when coupled to the dental base station, the weight of the coupler housing is support by the dental base station, and
wherein the electrical power source is at least partially housed by the coupler housing.

14. The coupling device of claim 1, further comprising a coupler housing fixedly coupled to a first length of hose, wherein the electrical power source is at least partially housed by the coupler housing,
wherein the coupler housing is selectively coupleable to a second length of hose coupling the first end of the coupling device to the dental base station and configured to convey the gaseous or fluid medium from the dental base station to the first end of the coupling device, and
wherein the first length of hose is selectively coupleable directly to the dental handpiece and configured to convey the gaseous or fluid medium from the coupler housing to the dental handpiece.

15. The coupling device of claim 1, further comprising a coupler housing including the first end and the second end of the coupling device,
wherein the first end of the coupler housing is selectively coupleable to a first hose coupling the coupler housing to the dental base station, and
wherein the second end of the coupler housing is selectively coupleable to a second hose coupling the coupler housing to the dental handpiece.

16. The coupling device of claim 1, wherein the coupling device is configured to retrofit the dental handpiece that requires the gaseous or fluid medium and electrical power for operation to the dental base station that is not configured to provide electrical power for operation of the dental handpiece.

17. The coupling device of claim 1, wherein the gaseous or fluid medium includes one selected from a group consisting of air and water.

18. A method of retrofitting a dental handpiece to a dental base station, wherein the dental handpiece requires both electrical power and a gaseous or fluid medium for operation, and wherein the dental base station is configured to provide the gaseous or fluid medium to the dental handpiece but is not configured to provide electrical power to the dental handpiece, the method comprising:
coupling the dental base station to a first end of a coupling device;
coupling the dental handpiece to a second end of the coupling device;
conveying the gaseous or fluid medium from the dental base station to the dental handpiece through the coupling device; and
conveying the electrical power to the dental handpiece from a power supply at least partially housed by the coupling device.

19. The method of claim 18, further comprising:
transmitting data between the dental handpiece and an external computer system through a wired communication link between the dental handpiece and a wireless data transceiver of the coupling device and through a wireless communication link between the wireless data transceiver of the coupling device and the external computer system.

20. The method of claim 18, wherein coupling the dental base station to a first end of the coupling device includes
coupling a first end of a flexible hose to the first end of the coupling device, and
coupling a second end of the flexible hose to the dental base station.
